(19) United States
(12) Patent Application Publication
(10) Pub. No.: US 2014/0123077 A1
(43) Pub. Date: May 1, 2014

(54) SYSTEM AND METHOD FOR USER INTERACTION AND CONTROL OF ELECTRONIC DEVICES

(71) Applicant: Intel Corporation, Santa Clara, CA (US)

(72) Inventors: Gershom Kutliroff, Alon Shvut (IL); Yaron Yanai, Modiin (IL); Eli Elhadad, Moshav Kidron (IL)

(73) Assignees: Intel Corporation, Santa Clara, CA (US); Omek Interactive, Ltd., Bet Shemesh (IL)

(21) Appl. No.: 13/676,017

(22) Filed: Nov. 13, 2012

Related U.S. Application Data
(60) Provisional application No. 61/719,828, filed on Oct. 29, 2012.

(51) Int. Cl. G06F 3/01

(52) U.S. Cl. CPC G06F 3/017
USPC 715/863

(57) ABSTRACT

A system and method for close range object tracking are described. Close range depth images of a user's hands and fingers are acquired using a depth sensor. Movements of the user's hands and fingers are identified and tracked. This information is used to permit the user to interact with a virtual object, such as an icon or other object displayed on a screen, or the screen itself.

### CROSS-REFERENCE TO RELATED APPLICATIONS

This application claims priority from U.S. Provisional Patent Application No. 61/719,828, filed Oct. 29, 2012, entitled “SYSTEM AND METHOD FOR USER INTERACTION AND CONTROL OF ELECTRONIC DEVICES”, which is incorporated by reference in its entirety.

### BACKGROUND

To a large extent, humans' interactions with electronic devices, such as computers, tablets, and mobile phones, require physically manipulating controls, pressing buttons, or touching screens. For example, users interact with computers via input devices, such as a keyboard and mouse. While a keyboard and mouse are effective for functions such as entering text and scrolling through documents, they are not effective for many other ways in which a user could interact with an electronic device. A user's hand holding a mouse is constrained to move only along flat two-dimensional (2D) surfaces, and navigating with a mouse through three dimensional virtual spaces is clumsy and non-intuitive. Similarly, the flat interface of a touch screen does not allow a user to convey any notion of depth. These devices restrict the full range of possible hand and finger movements to a limited subset of two dimensional movements that conform to the constraints of the technology.

### BRIEF DESCRIPTION OF THE DRAWINGS

Examples of a system and method for providing a user interaction experience based on depth images are illustrated in the figures. The examples and figures are illustrative rather than limiting.

FIG. 1 is a diagram illustrating an example environment in which two cameras are positioned to view an area.

FIG. 2 is a diagram illustrating an example environment in which multiple cameras are used to capture user interactions.

FIG. 3 is a diagram illustrating an example environment in which multiple cameras are used to capture interactions by multiple users.

FIG. 4 is a schematic diagram illustrating control of a remote device through tracking of a user's hands and/or fingers.

FIGS. 5A-5F show graphic illustrations of examples of hand gestures that may be tracked. FIG. 5A shows an upturned open hand with the fingers spread apart; FIG. 5B shows a hand with the index finger pointing outwards parallel to the thumb and the other fingers pulled toward the palm; FIG. 5C shows a hand with the thumb and middle finger forming a circle with the other fingers outstretched; FIG. 5D shows a hand with the thumb and index finger forming a circle and the other fingers outstretched; FIG. 5E shows an open hand with the fingers touching and pointing upward; and FIG. 5F shows the index finger and middle finger spread apart and pointing upwards with the ring finger and pinky finger curled toward the palm and the thumb touching the ring finger.

FIGS. 6A-6D show additional graphic illustrations of examples of hand gestures that may be tracked. FIG. 6A shows a dynamic wave-like gesture;

FIG. 6B shows a loosely-closed hand gesture; FIG. 6C shows a hand gesture with the thumb and forefinger touching; and FIG. 6D shows a dynamic swiping gesture.

FIG. 7 is a flow diagram illustrating an example process for depth camera object tracking.

FIG. 8 is a flow diagram illustrating an example process for interacting with a user interface element.

FIG. 9 is a flow diagram illustrating an example process for implementing a user interaction scheme involving select gestures and release gestures.

FIG. 10 is a flow diagram illustrating an example process for implementing a user interaction scheme related to menus.

FIG. 11 is a flow diagram illustrating an example process for controlling a position of a cursor on a screen using movements of the fingers.

FIG. 12 depicts an exemplary architecture of a processor that implements user interface techniques based on depth data.

FIG. 13 is a block diagram showing an example of the architecture for a processing system that can be utilized to implement user interface techniques according to an embodiment of the present disclosure.

### DETAILED DESCRIPTION

A system and method enabling a user to touchlessly interact with an electronic device are described. The methods described in the current invention assume a highly accurate and robust ability to track the movements of the user's fingers and hands. It is possible to obtain the required accuracy and robustness through specialized algorithms that process the data captured by a depth camera. Once the movements and three dimensional (3D) configurations of the user's hands are recognized, they can be used to control a device, either by mapping the locations of the user's movements to a display screen, or by understanding specific gestures performed by the user. In particular, the user's hands and fingers can be visualized in some representation on a screen, such as a mouse cursor, and this representation of the user's hands and fingers can be manipulated to interact with other, virtual, objects that are also displayed on the screen.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The current disclosure describes a user interaction mechanism in which a virtual environment, such as a computer screen, is controlled by unrestricted, natural movements of the user's hands and fingers. The enabling technology for this invention is a system that is able to accurately and robustly track the movements of the user's hands and fingers in real-time, and to use the tracked movements to identify specific gestures performed by the user.

The system should be able to identify the configurations and movements of a user's hands and fingers. Conventional cameras, such as “RGB” (“red-green-blue”), also known as “2D” cameras, are insufficient for this purpose, as the data generated by these cameras is difficult to interpret accurately and robustly. In particular, it can be difficult to distinguish the objects in an image from the image background, especially when such objects occlude one another. Additionally, the sensitivity of the data to lighting conditions means that changes in the values of the data may be due to lighting effects, rather than changes in the object's position or orientation. In contrast, depth cameras generate data that can support highly accurate, robust tracking of objects. In particular, the data from depth cameras can be used to track the user's hands and fingers, even in cases of complex hand articulations.

A depth camera captures depth images, generally a sequence of successive depth images, at multiple frames per second. Each depth image contains per-pixel depth data, that is, each pixel in the image has a value that represents the distance between a corresponding object in an imaged scene and the camera. Depth cameras are sometimes referred to as three-dimensional (3D) cameras. A depth camera may contain a depth image sensor, an optical lens, and an illumination source, among other components. The depth image sensor may rely on one of several different sensor technologies. Among these sensor technologies are time-of-flight, known as “TOF”, (including scanning TOF or array TOF), structured light, laser speckle pattern technology, stereoscopic cameras, active stereoscopic sensors, and shape-from-shading technology. Most of these techniques rely on active sensors that supply their own illumination source. In contrast, passive sensor techniques, such as stereoscopic cameras, do not supply their own illumination source, but depend instead on ambient environmental lighting. In addition to depth data, the cameras may also generate color data, in the same way that conventional color cameras do, and the color data can be combined with the depth data for processing.

The data generated by depth cameras has several advantages over that generated by conventional, “2D” cameras. In particular, the depth data greatly simplifies the problem of segmenting the background of a scene from objects in the foreground, is generally robust to changes in lighting conditions, and can be used effectively to interpret occlusions. Using depth cameras, it is possible to identify and track both the user's hands and fingers in real-time.

U.S. patent application Ser. No. 13/532,609, entitled “System and Method for Close-Range Movement Tracking” describes a method for tracking a user's hands and fingers based on depth images captured from a depth camera, and using the tracked data to control a user's interaction with devices, and is hereby incorporated by reference in its entirety. U.S. patent application Ser. No. 13/441,271, entitled “System and Method for Enhanced Object Tracking”, filed Apr. 6, 2012, describes a method of identifying and tracking a user's body part or parts using a combination of depth data and amplitude data from a time-of-flight (TOF) camera, and is hereby incorporated by reference in its entirety in the present disclosure.

For the purposes of this disclosure, the term “gesture recognition” refers to a method for identifying specific movements or pose configurations performed by a user. For example, gesture recognition can refer to identifying a swipe of a hand in a particular direction having a particular speed, a finger tracing a specific shape on a touch screen, or a wave of a hand. Gesture recognition is accomplished by first tracking the depth data and identifying features, such as the joints, of the user's hands and fingers, and then, subsequently, analyzing the tracked data to identify gestures performed by the user.

The present disclosure describes a user interaction system enabled by highly accurate and robust tracking of a user's hands and fingers achieved by using a combination of depth cameras and tracking algorithms. In some cases, the system may also include a gesture recognition component that receives the tracking data as input and decides whether the user has performed a specific gesture, or not.

The user's unrestricted, natural hand and finger movements can be used to control a virtual environment. There are several advantages to such a user interaction mechanism over standard methods of user interaction and control of electronic devices, such as a mouse and keyboard and a touchscreen. First, the user does not have to extend his arm to touch a screen, which can cause fatigue and also block the user's view of the screen. Second, movements in 3D space provide more degrees of freedom. Third, depending on the field-of-view of the camera, the user may have a larger interaction area in which to move around than just the screen itself.

In one embodiment, a user may swipe his hand or one or more fingers or flick one or more fingers toward the center of a monitor display to bring up a menu. The direction from which the swipe gesture originates or ends can determine where on the display the menu is displayed. For example, a swipe gesture horizontally from the right to the left can be associated with displaying the menu at the right edge of the screen (the origination direction of the swipe gesture) or the left edge of the screen (the destination direction of the swipe gesture). Subsequently, the user may use a finger to select items on the displayed menu and swipe with his finger to launch the selected item. Additionally, an opposite swipe, in the other direction, can close the menu.

In another embodiment, the user may select an icon or other object on the monitor display by pointing at it with his finger, and move the icon or object around the monitor by pointing his finger at different regions of the display. He may subsequently launch or maximize an application represented by the icon or object by opening his hand and close or minimize the application by closing his hand.

In a further embodiment, the user may select the display screen itself, instead of an object. In this case, movements of the hand or finger may be mapped to scrolling of the display screen. In an additional embodiment, by mapping the rotations of the user's hand to the object, the user may select an object on the monitor display and rotate it along one or more axes. Furthermore, the user may rotate two objects in such a way simultaneously, one with each hand.

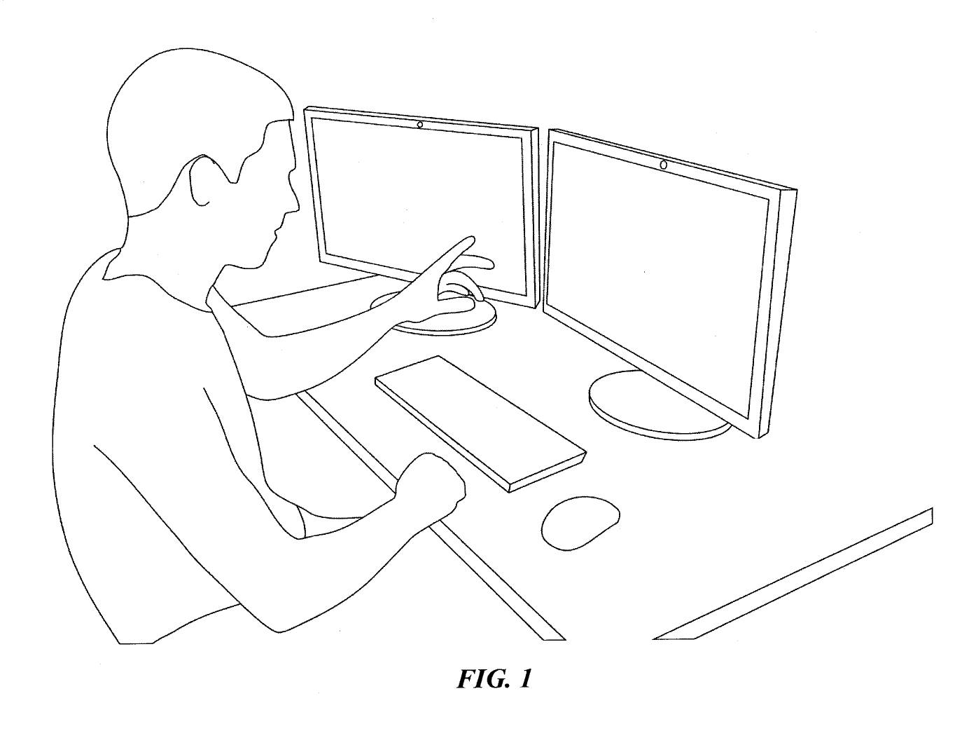

FIG. 1 is a diagram of a user interacting with two monitors at close-range. In one embodiment, there may be a depth camera on each of the two monitors. In another embodiment, only one of the monitors may have a depth camera. The user is able to interact with the screens by moving his hands and fingers. The depth camera captures live video of the user's movements, and algorithms are applied to the captured depth images to interpret the movements and deduce the user's intentions. Some form of feedback to the user is then displayed on the screens.

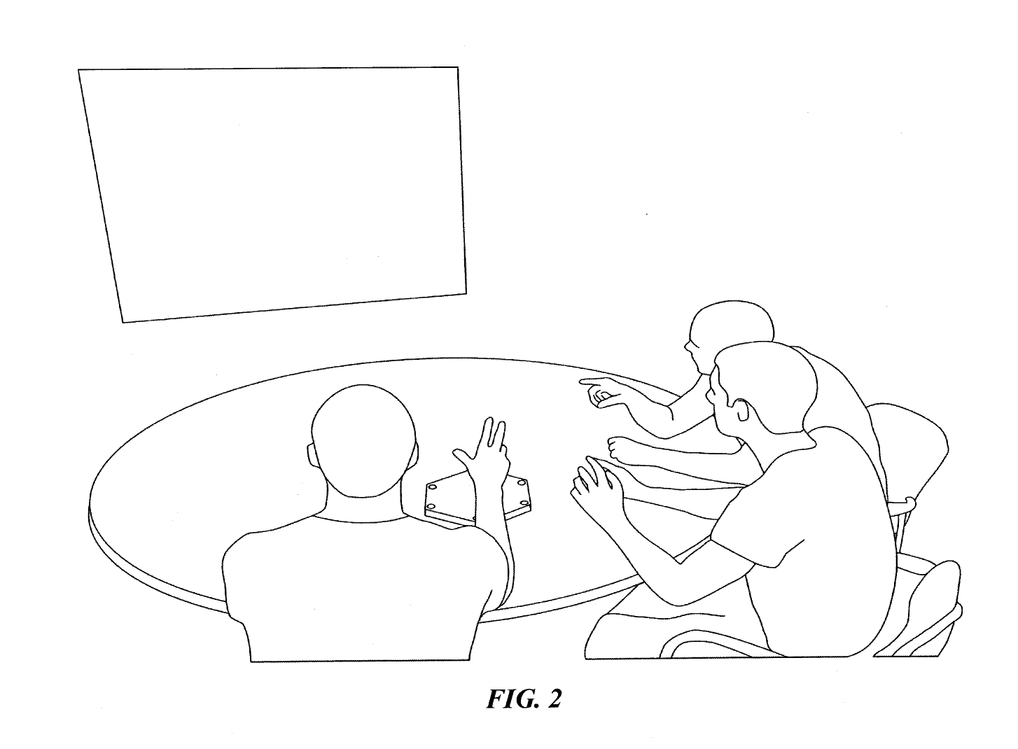

FIG. 2 is a diagram of another embodiment of the current invention. In this embodiment, a standalone device can contain a single depth camera, or multiple depth cameras, positioned around the periphery. Individuals can interact with their environment via the movements of their hands and fingers. The movements are detected by the camera and interpreted by the tracking algorithms.

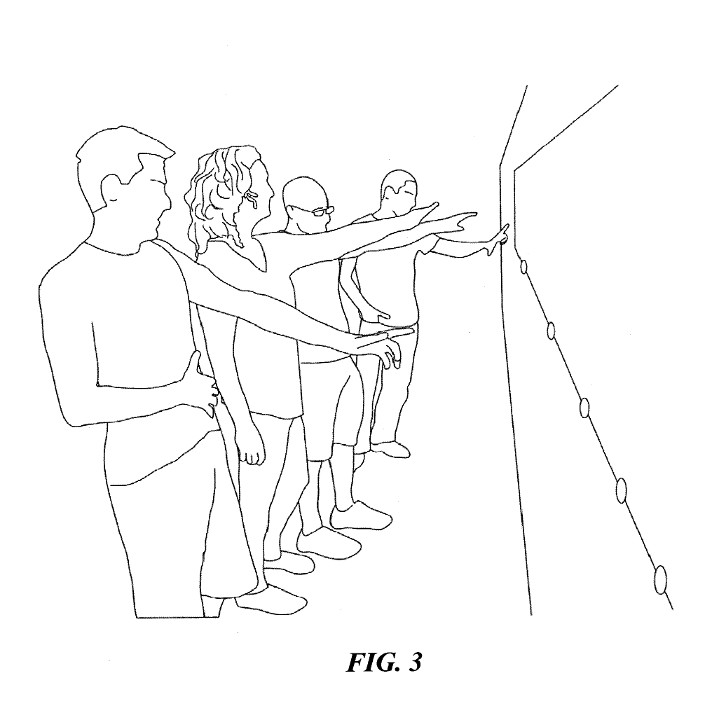

FIG. 3 is a diagram of a further embodiment of the current invention, in which multiple users interact simultaneously with an application designed to be part of an installation. In this embodiment as well, the movements of the users' hands and fingers control their virtual environment via a depth camera that captures live video of their movements. Tracking algorithms interpret the movements captured by the video to identify their movements.

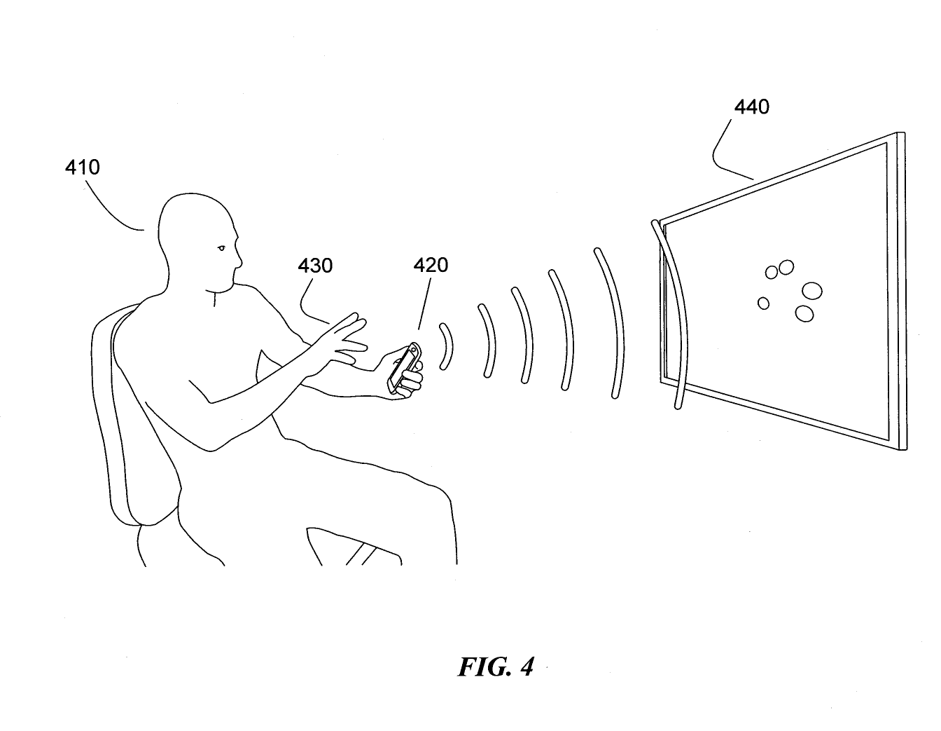

FIG. 4 is a diagram of another embodiment of the current invention, in which a user 410 moves his hands and fingers 430 while holding a handheld device 420 containing a depth camera. The depth camera captures live video of the movements and tracking algorithms are run on the video to interpret his movements. Further processing translates the user's hand and/or finger movements into gestures, which are used to control the large screen 440 in front of the user.

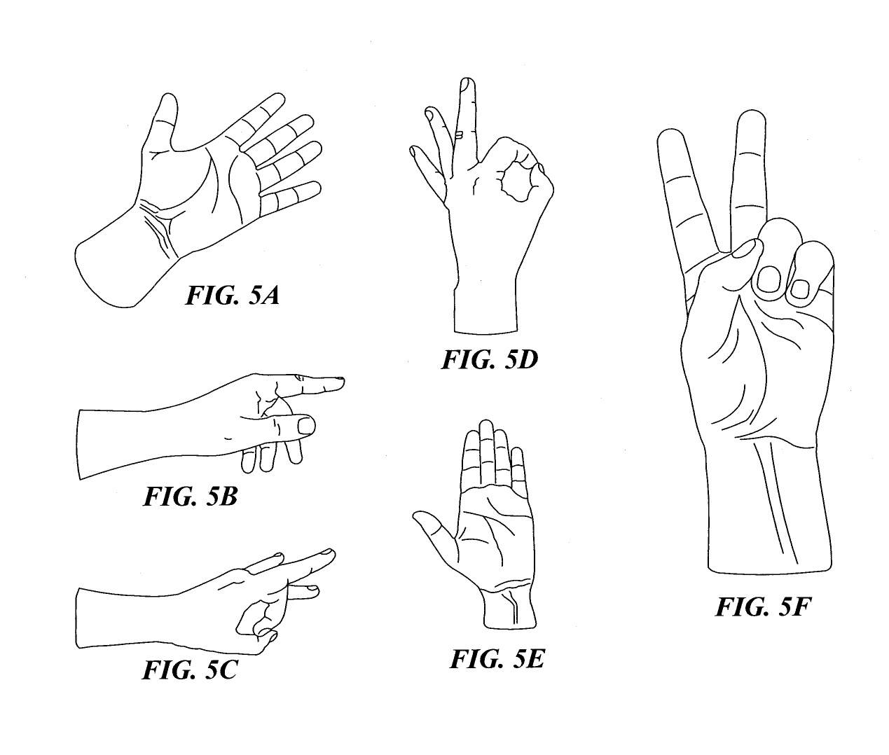

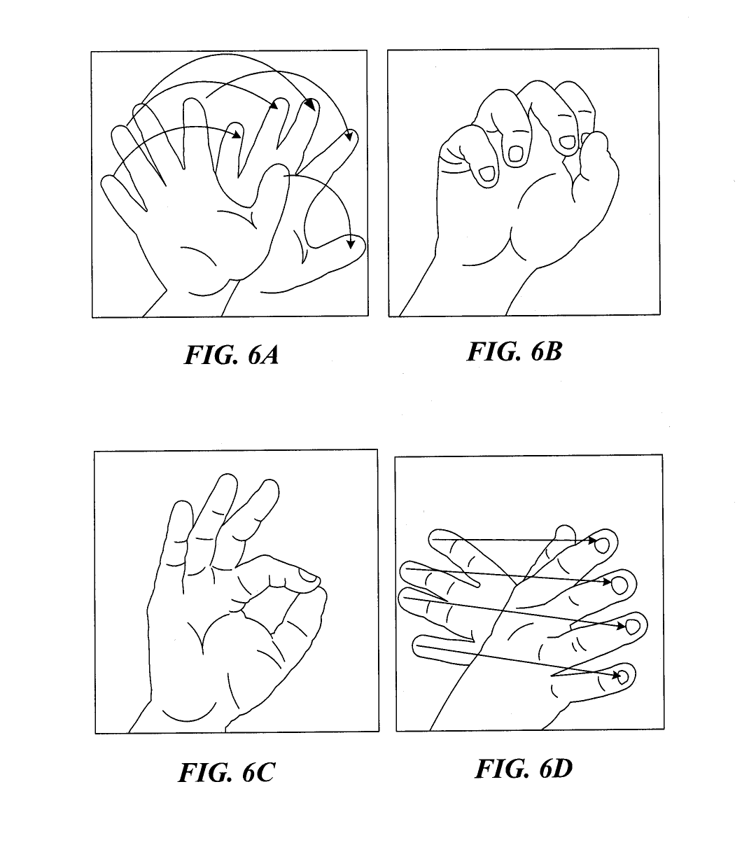

FIG. 5 is a diagram of several example gestures that can be detected by the tracking algorithms. FIGS. 6A-6D are diagrams of an additional four example gestures that can be detected by the tracking algorithms. The arrows in the diagrams refer to movements of the fingers and hands, where the movements define the particular gesture. These examples of gestures are not intended to be restrictive. Many other types of movements and gestures can also be detected by the tracking algorithms.

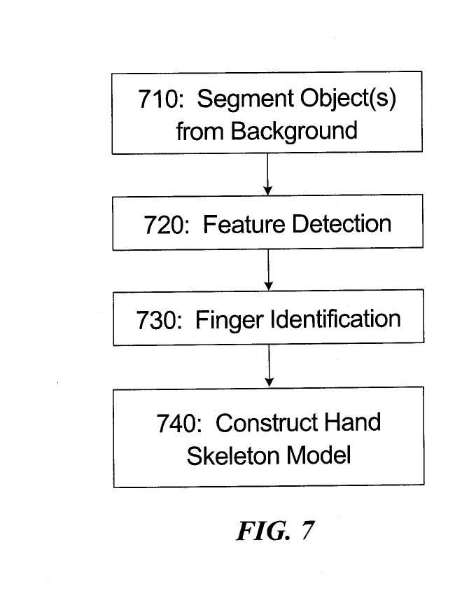

FIG. 7 is a workflow diagram, describing an example process of tracking a user's hand(s) and finger(s). At stage 710, an object is segmented and separated from the background. This can be done, for example, by thresholding the depth values, or by tracking the object's contour from previous frames and matching it to the contour from the current frame. In one embodiment, the user's hand is identified from the depth image data obtained from the depth camera, and the hand is segmented from the background. Unwanted noise and background data is removed from the depth image at this stage.

Subsequently, at stage 720, features are detected in the depth image data and associated amplitude data and/or associated RGB images. These features may be, in one embodiment, the tips of the fingers, the points where the bases of the fingers meet the palm, and any other image data that is detectable. The features detected at 720 are then used to identify the individual fingers in the image data at stage 730.

At stage 740, the 3D points of the fingertips and some of the joints of the fingers may be used to construct a hand skeleton model. The skeleton model may be used to further improve the quality of the tracking and assign positions to joints which were not detected in the earlier steps, either because of occlusions, or missed features, of from parts of the hand being out of the camera's field-of-view. Moreover, a kinematic model may be applied as part of the skeleton, to add further information that improves the tracking results.

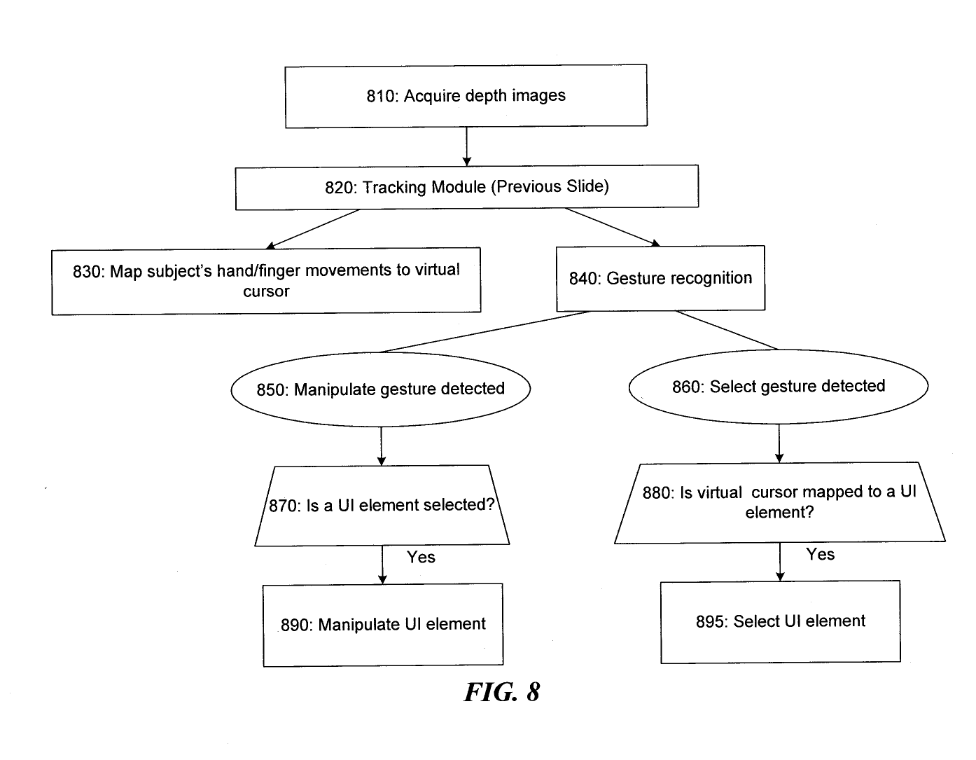

Reference is now made to FIG. 8, which illustrates an example of a user interface (UI) framework, based on close-range tracking enabling technology. The gesture recognition component may include elements described in U.S. Pat. No. 7,970,176, entitled “Method and System for Gesture Classification”, and U.S. application Ser. No. 12/707,340, entitled, “Method and System for Gesture Recognition”, which are incorporated herein by reference in their entireties.

At stage 810, depth images are acquired from a depth camera. At stage 820, a tracking module performs the functions described in FIG. 7 using the obtained depth images. The joint position data generated by the tracking module is then processed in two parallel paths, as described below. At stage 830, the joint position data is used to map or project the subject's hand and/or finger movements to a virtual cursor. Optionally, a cursor or command tool may be controlled by one or more of the subject's fingers. Information may be provided on a display screen to provide feedback to the subject. The virtual cursor can be a simple graphical element, such as an arrow, or a representation of a hand. It may also simply highlight or identify a UI element (without the explicit graphical representation of the cursor on the screen), such as by changing the color of the UI element, or projecting a glow behind it. Different parts of the subject's hand(s) can be used to move the virtual cursor. The virtual cursor can also be used to select the screen as an object to be manipulated.

At stage 840, the position data of the joints is used to detect gestures that may be performed by the subject. There are two categories of gestures that trigger events: selection gestures and manipulation gestures. Selection gestures indicate that a specific UI element should be selected. In some embodiments, a selection gesture is a grabbing movement with the hand, where the fingers move towards the center of the palm, as if the subject is picking up the UI element. In another embodiment, a selection gesture is performed by moving a finger or a hand in a circle, so that the virtual cursor encircles the UI element that the subject wants to select. Of course, other gestures may be used.

At stage 860, the system evaluates whether a selection gesture was detected at stage 840, and, if so, at stage 880 the system determines whether a virtual cursor is currently mapped to one or more UI elements. The virtual cursor is mapped to a UI element when the virtual cursor is moved over that UI element. In the case where a virtual cursor has been mapped to a UI element(s), the UI element(s) may be selected at stage 895.

In addition to selection gestures, another category of gestures, manipulation gestures, are defined. Manipulation gestures may be used to manipulate a UI element in some way. In some embodiments, a manipulation gesture is performed by the subject rotating his/her hand, which in turn, rotates the UI element that has been selected, so as to display additional information on the screen. For example, if the UI element is a directory of files, rotating the directory enables the subject to see all of the files contained in the directory. Additional examples of manipulation gestures can include turning the UI element upside down to empty its contents, for example, onto a virtual desktop; shaking the UI element to reorder its contents, or have some other effect; tipping the UI element so the subject can “look inside”; squeezing the UI element, which may have the effect, for example, of minimizing the UI element; or moving the UI element to another location. In another embodiment, a swipe gesture can move the selected UI element to the recycle bin.

At stage 850, the system evaluates whether a manipulation gesture has been detected. If a manipulation gesture was detected, subsequently, at stage 870, the system checks whether there is a UI element that has been selected. If a UI element has been selected, it may then be manipulated at stage 890, according to the particular defined behavior of the performed gesture, and the context of the system. In some embodiments, one or more respective cursors identified with the respective fingertips may be managed, to enable navigation, command entry or other manipulation of screen icons, objects or data, by one or more fingers.

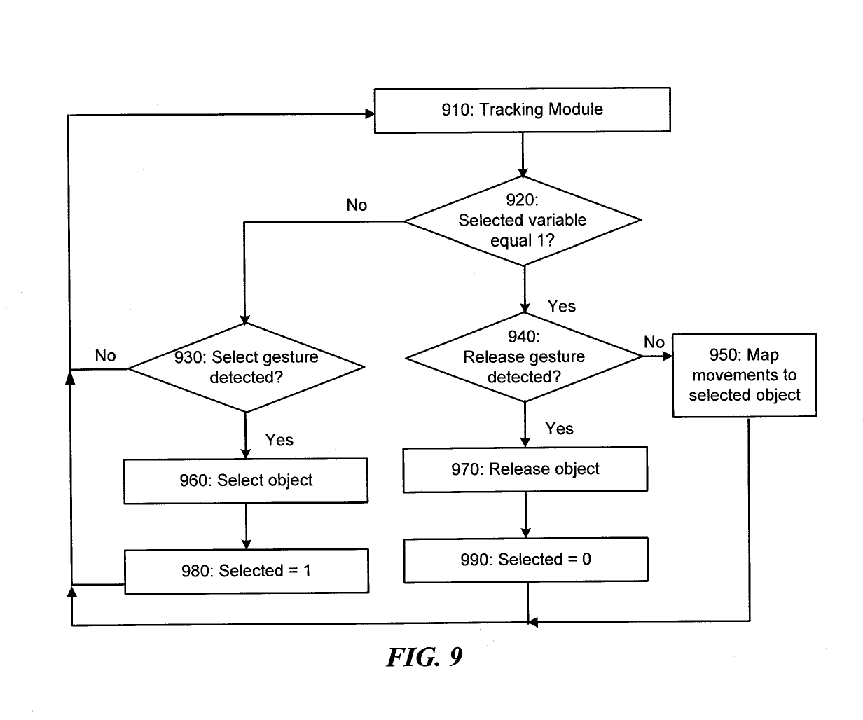

FIG. 9 is a workflow diagram of a specific user interaction scheme. At stage 910, a tracking module performs the functions described in FIG. 7 using depth images captured by a depth camera. The output of the tracking module is passed to stage 920, where the system evaluates whether the state variable Selected is equal to 0 (corresponding to no object selected), or is equal to 1 (corresponding to an object selected).

If the Selected variable is equal to 0, at stage 930 the system evaluates whether a select gesture is detected. If a select gesture is indeed detected, at stage 960, the object corresponding to the current location of the cursor is selected. This object may be an icon on the desktop, or it may be the background desktop itself. Subsequently, at stage 980, the Selected variable is set to 1, since now an object has been selected. In one embodiment, a select gesture is a pinch of the thumb and forefinger together. In another embodiment, the select gesture is a grab gesture, in which all of the fingers are folded in towards the center of the hand. The process returns to stage 910 to continue tracking user hand and finger movements.

If at stage 930 no select gesture is detected, the process returns to stage 910 to continue tracking user hand and finger movements.

If, at stage 920, the Selected state variable was found to be equal to 1, i.e., an object was selected, at stage 940 the system evaluates whether a release gesture is detected. In one embodiment in which the select gesture is a pinch, the release gesture is the opposite motion, in which the thumb and forefinger separate. In one embodiment in which the select gesture is a grab, the release gesture is the opposite motion, in which the fingers open away from the center of the palm.

If, at stage 940, a release gesture was detected, the object that was selected previously is released at stage 970. If this object was an icon, releasing the object corresponds to letting it rest on the desktop. If the object selected was the desktop screen itself, releasing the object corresponds to freezing the position of the desktop background. Subsequently, at stage 990, the Selected variable is set to 0 so that the previously selected object is deselected. The process returns to stage 910 to continue tracking user hand and finger movements.

If, at stage 940, a release gesture was not detected, then, at stage 950, the user's hand(s) and/or finger movements are mapped to the object that was previously selected. In the case in which the selected object is an icon, this corresponds to moving the icon across the desktop screen according to the user's movements. In the case in which the selected object is the desktop screen itself, this corresponds to moving the entire desktop, e.g., scrolling up and down and from right to left. The system determines whether an icon or the screen itself is selected based on the position of the cursor on the screen when a select gesture is detected. If the cursor is positioned between virtual objects when the select gesture is detected, the screen itself is selected, and if the cursor is positioned on top of a virtual object when the select gesture is detected, the virtual object is selected.

Whether the selected object is an icon, virtual object, or the screen, depth movements of the user's hand(s) and/or fingers, that is, movements that change the distance between the user and the screen, can also be mapped to an attribute of the selected object. In one embodiment, changing the depth movements of the user's hand changes the size of the selected icon. For example, if a selected virtual object is a paintbrush tool, the size or width of the paintbrush tool can be controlled by the distance between the screen and the user's hand(s) and/or fingers. In one embodiment, the distance may be determined by a particular point on the user's hand and/or fingers or an average of several points. Alternatively, in the case in which the selected object is the desktop or screen itself, changing the depth measurements can correspond to zooming in and out of the desktop or screen.

The process returns to stage 910 to continue tracking user hand and finger movements.

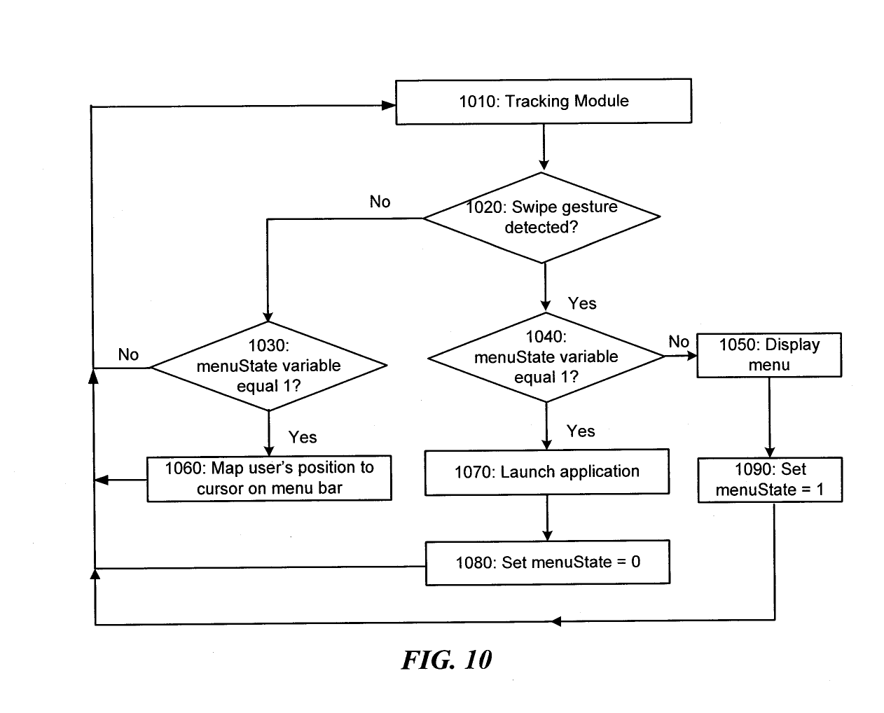

FIG. 10 is a workflow diagram of a specific user interaction scheme related to menus. At stage 1010, a tracking module performs the functions described in FIG. 7 using depth images captured by a depth camera. The output of the tracking module is passed to stage 1020, at which the system evaluates whether a swipe gesture has been detected. There are different ways in which the swipe gesture can be performed by the user. In one embodiment, the swipe gesture corresponds to a swipe of either of the user's hands, either horizontally, as in FIG. 6D, or vertically. In another embodiment, the swipe gesture corresponds to flicking a finger from either hand, either vertically, or horizontally.

If a swipe gesture was not detected, at stage 1030 the system checks the current value of the menuState state variable. The menuState state variable can take on a value of either 1 or 0. If the menuState variable equals 1, there is a menu currently displayed on the screen. Otherwise, the menuState variable equals 0. If the menuState state variable is found to be “1” at stage 1030, indicating that the menu is currently displayed on the screen, then at stage 1060, the position of a user's hand or a finger is mapped to the cursor on the screen. In one embodiment, then, if the user moves his hand vertically, the cursor, mapped to the screen, moves accordingly, hovering over one of the icons in the menu. The process returns to stage 1010 to continue tracking user hand and finger movements.

If at stage 1030 the menuState state variable equals 0, indicating that no menu is currently displayed on the screen, the process returns to stage 1010 to continue tracking user hand and finger movements. Returning to stage 1020, if the swipe gesture was detected, then at stage 1040 the system evaluates the menuState state variable to determine whether the menu is displayed on the screen (“1”) or not (“0”). If the menuState state variable is “1”, indicating the menu is currently displayed on the screen, then the application corresponding to the current location of the cursor is launched at stage 1070. Subsequently, the menuState is set to “0” at stage 1080, since the menu is no longer displayed on the screen. The process returns to stage 1010 to continue tracking user hand and finger movements.

At stage 1040, if the menuState state variable is “0”, that is, there is nomenu currently displayed, then at stage 1050 the appropriate menu is displayed, according to the swipe gesture that was detected at stage 1020. The menu may display several objects, possibly represented as icons, and a cursor may be overlaid on one of the objects of the menu. Once the menu is displayed, movements of the user's hands or fingers may be mapped to the cursor. In one embodiment, movements of the user's hand may move the cursor from one icon to an adjacent icon. In this way, the user is able to position the cursor over an icon so that the application corresponding to the icon can then be selected and activated. After the menu is displayed, at stage 1090, the menuState state variable is set to “1”, indicating that the menu is currently displayed on the screen. The process then returns to stage 1010 to continue tracking user hand and finger movements.

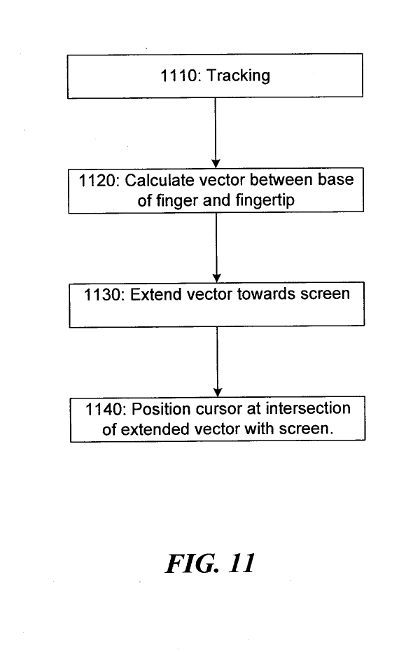

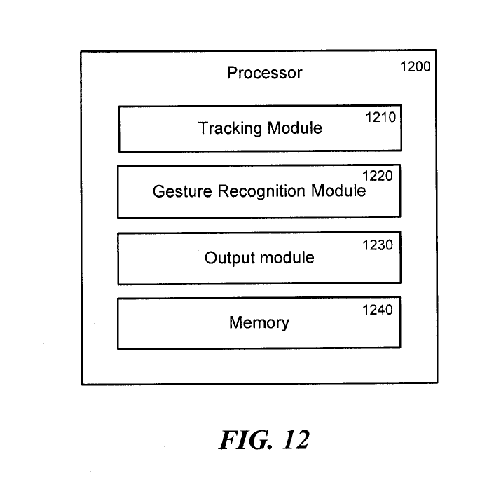

FIG. 11 is a workflow diagram of a specific user interaction scheme. At stage 1110, a tracking module performs the functions described in FIG. 7 using depth images captured by a depth camera. Subsequently, at stage 1120, the positions of the joints obtained at stage 1110 may be used to calculate a vector between the base of a finger and the tip of the finger. At stage 1130, this vector can be extended toward the screen, until it intersects with the screen in 3D space. Then at stage 1140, the region of the screen corresponding to the extended vector is computed, and a cursor may be positioned within this region. In this way, the user's finger may control the position of the cursor on the screen, by pointing to different regions. FIG. 12 is an example of an architecture of a processor 1200 configured, for example, to track user hand and finger movements based on depth data, identify movements as gestures, map the movements to control a device, and provide feedback to the user. In the example of FIG. 12, the processor 1200 (and all of the elements included within the processor 1200) is implemented by using programmable circuitry programmed by software and/or firmware, or by using special-purpose hardwired circuitry, or by using a combination of such embodiments.

In the example of FIG. 12, the processor 1200 includes a tracking module 1210, a gesture recognition module 1220, an output module 1230, and a memory 1240. Additional or fewer components or modules can be included in the processor 1200 and each illustrated component.

As used herein, a “module” includes a general purpose, dedicated or shared processor and, typically, firmware or software modules that are executed by the processor. Depending upon implementation-specific or other considerations, the module can be centralized or its functionality distributed. The module can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

In one embodiment, the processor 1200 includes a tracking module 1210 configured to receive depth data, segment and separate an object from the background, detect hand features in the depth data and any associated amplitude and/or color images, identify individual fingers in the depth data, and construct a hand skeleton model. The tracking module 1210 can use the hand skeleton model to improve tracking results.

In one embodiment, the processor 1200 includes a gesture recognition module 1220 configured to identify pre-defined gestures that may be included in a gesture library. The gesture recognition module 1220 can further classify identified gestures as select gestures, manipulate gestures, and release gestures.

In one embodiment, the processor 1200 includes an output module 1230 configured to process tracked movements from the tracking module 1210 and identified gestures from the gesture recognition module 1220 to map tracked movements to a selected virtual object. In one embodiment, the output module 1230 communicates, wired or wirelessly, with an application that runs a user interface of a device to be controlled, and the output module 1230 provides the information from the tracking module 1210 and gesture recognition module 1220 to the application. For example, the gesture recognition module 1220 can interpret a movement as a sideways swipe gesture, and the output module 1230 can associate the sideways swipe gesture as a request to display a menu on the right edge of a screen and send the information to the application; or the output module 1230 can map movements of the user's hand(s) and/or finger(s) to a selected virtual object and send the information to the application. Alternatively, the application can run in the processor 1200 and communicate directly with the output module 1230.

In one embodiment, the processor 1200 includes a memory 1240 configure to store data, such as the state of state variables, e.g. the state variables Selected and menuState, and a gesture library. The information stored in the memory 1240 can be used by the other modules in the processor 1200.

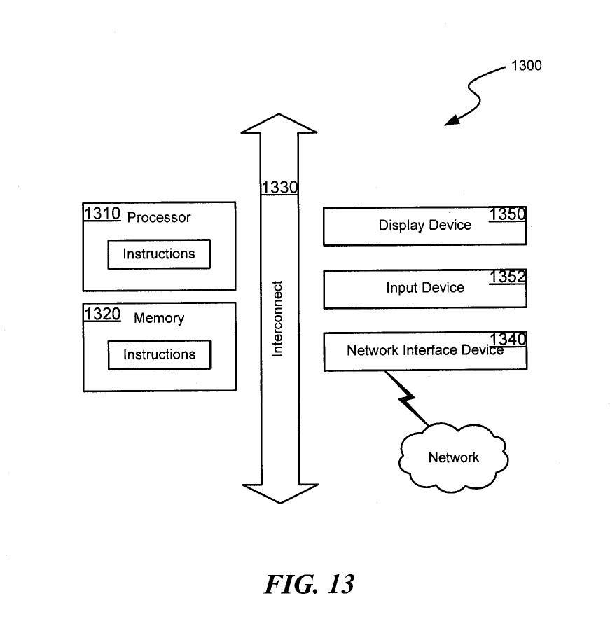

FIG. 13 is a block diagram showing an example of the architecture for a system 1300 that can be utilized to implement the techniques described herein. In FIG. 13, the system 1300 includes one or more processors 1310 and memory 1320 connected via an interconnect 1330. The interconnect 1330 is an abstraction that represents any one or more separate physical buses, point to point connections, or both connected by appropriate bridges, adapters, or controllers. The interconnect 1330, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 1310 can include central processing units (CPUs) that can execute software or firmware stored in memory 1320. The processor(s) 1310 may be, or may include, one or more programmable general-purpose or special-purpose microprocessors, digital signal processors (DSPs), programmable, application specific integrated circuits (ASICs), programmable logic devices (PLDs), or the like, or a combination of such devices.

The memory 1320 represents any form of memory, such as random access memory (RAM), read-only memory (ROM), flash memory, or a combination of such devices. In use, the memory 1320 can contain, among other things, a set of machine instructions which, when executed by processor 1310, causes the processor 1310 to perform operations to implement embodiments of the present invention.

Also connected to the processor(s) 1310 through the interconnect 1330 is a network interface device 1340. The network interface device 1340 provides the system 1300 with the ability to communicate with remote devices, such as remote depth cameras or devices to be controlled, and may be, for example, an Ethernet adapter or Fiber Channel adapter.

The system 1300 can also include one or more optional input devices 1352 and/or optional display devices 1350. Input devices 1352 can include a keyboard. The display device 1350 can include a cathode ray tube (CRT), liquid crystal display (LCD), or some other applicable known or convenient display device.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference in their entireties. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method for operating a user interface, the method comprising:
acquiring close range depth images of a user's hands and fingers with a depth sensor;
tracking one or more first movements of the user's hands and fingers based on the acquired depth images;
identifying a first select gesture from the tracked one or more first movements, wherein the first select gesture selects a first virtual object displayed on a screen.

2. The method of claim 1, further comprising:
tracking one or more second movements of the user's hands and fingers based on the acquired depth images;
mapping the one or more second movements to the first virtual object;
identifying a release gesture from the tracked one or more second movements, wherein the release gesture releases the first virtual object displayed on the screen.

3. The method of claim 2, wherein the first select gesture is a pinch of the thumb and forefinger, and the release gesture is a release of the pinch comprising spreading the thumb and forefinger apart.

4. The method of claim 2, wherein the first select gesture is a grab gesture comprising folding fingers toward the hand, and further wherein the release gesture comprises opening the fingers away from the hand.

5. The method of claim 2, wherein the one or more second movements mapped to the first virtual object correspondingly move the first virtual object on the screen.

6. The method of claim 5, wherein the one or more second movements comprise movement of the hand and fingers relative to the screen, and further wherein movement of the hand and fingers toward the screen enlarges the first virtual object displayed on the screen and movement of the hand and fingers away from the screen shrinks the first virtual object displayed on the screen.

7. The method of claim 5, wherein the one or more second movements comprises movements of the hand and fingers along a trajectory in three-dimensional space, and the first virtual object is animated along a corresponding trajectory on the screen.

8. The method of claim 1, further comprising:
identifying a second select gesture from the tracked one or more first movements, wherein the second select gesture selects a second virtual object displayed on the screen, wherein the first virtual object is selected by the user's first hand, and the second virtual object is selected by the user's second hand;
tracking one or more second movements of the user's hands and fingers based on the acquired depth images;
mapping a first subset of the one or more second movements corresponding to the user's first hand to the first virtual object;
mapping a second subset of the one or more second movements corresponding to the user's second hand to the second virtual object;
identifying a first release gesture from the tracked one or more second movements, wherein the first release gesture releases the first virtual object displayed on the screen;
identifying a second release gesture from the tracked one or more second movements, wherein the second release gesture releases the second virtual object displayed on the screen

9. A method for operating a user interface, the method comprising:
acquiring close range depth images of a user's hand and fingers with a depth sensor;
tracking one or more first movements of the user's hand and fingers based on the acquired depth images;
identifying a first select gesture from the tracked one or more first movements, wherein the first select gesture selects at least a portion of a screen;
mapping movements of the user's hand and fingers to scroll the at least a portion of the screen.

10. The method of claim 9, wherein the one or more first movements comprise movements of the hand and fingers relative to the screen, and further wherein movement of the hand and fingers toward the screen corresponds to zooming in to the displayed screen and movement of the hand and fingers away from the screen corresponds to zooming out of the displayed screen.

11. A method for operating a user interface, the method comprising:
acquiring close range depth images of a user's hand and fingers with a depth sensor;
tracking movements of the user's hand and fingers;
upon identifying a first gesture from the tracked movements, displaying a menu of items along an edge of a screen, wherein the edge is selected based on a direction associated with the first gesture.

12. The method of claim 11, wherein the first gesture comprises a swipe gesture or a flick gesture.

13. The method of claim 11, wherein the direction associated with the first gesture is the direction from which the first gesture originated from.

14. The method of claim 11, further comprising mapping the movements of the user's hand and fingers to a cursor positioned on one of the items of the menu, wherein movements of the user's hand and fingers correspondingly move the cursor on the screen.

15. The method of claim 14, further comprising upon identifying a second gesture from the tracked movements, selecting the one of the items.

16. The method of claim 15, wherein the second gesture comprises a swipe gesture or a flick gesture.

17. The method of claim 15, further comprising mapping the movements of the user's hand and fingers to the selected one of the items, wherein movements of the user's hand and fingers correspondingly move the selected one of the items on the screen.

18. The method of claim 15, further comprising maximizing or launching the selected one of the items upon identifying an open hand gesture.

19. The method of claim 15, further comprising minimizing or closing the selected one of the items upon identifying a closed hand gesture.

20. A method for operating a user interface, the method comprising:
acquiring close range depth images of a user's hand and fingers with a depth sensor;
tracking movements of the user's hand and fingers based on the acquired depth images;
identifying a selection gesture from the tracked movements for selecting a virtual object on a screen;
changing an attribute of the virtual object based on the tracked movements.

21. The method of claim 20, wherein the attribute of the virtual object is based on a distance between the screen and the user's hand or fingers.

22. The method of claim 20, wherein the virtual object is a paintbrush, and further wherein the attribute is a size of the paintbrush.

23. A method for operating a user interface, the method comprising:
acquiring close range depth images of a user's hand and fingers with a depth sensor;
tracking movements of one of the user's fingers based on the depth images;
computing a vector between a base of the one of the user's fingers and a tip of the one of the user's fingers;
controlling a location of a cursor on a screen based at least on the vector.

24. An apparatus comprising:
means for acquiring close range depth images of a user's hands and fingers;
means for tracking one or more first movements of the user's hands and fingers based on the acquired depth images;
means for identifying a first select gesture from the tracked one or more first movements, wherein the first select gesture selects a first virtual object displayed on a screen.

25. The apparatus of claim 24, further comprising:
means for tracking one or more second movements of the user's hands and fingers based on the acquired depth images;
means for mapping the one or more second movements to the first virtual object;
means for identifying a release gesture from the tracked one or more second movements, wherein the release gesture releases the first virtual object displayed on the screen.
